(19) United States
(12) Patent Application Publication
(10) Pub. No.: US 2006/0240357 A1
(43) Pub. Date: Oct. 26, 2006

(54) Hybrid recordable optical record carrier

(76) Inventors: Hubert Cecile Francois Martens, Eindhoven (NL); Ruud Vlutters, Eindhoven (NL)

Correspondence Address: PHILIPS INTELLECTUAL PROPERTY & STANDARDS, P.O. BOX 3001, BRIARCLIFF MANOR, NY, 10510, US

(21) Appl. No.: 10/565,811

(22) PCT Filed: Jul. 19, 2004
(86) PCT No.: PCT/IB04/51253

§ 371 Date: Jan. 24, 2006

(30) Foreign Application Priority Data
Jul. 25, 2003 (EP) 03102304.7

(51) Int. Cl. G11B 7/24

(52) U.S. Cl. 430/270.11

(57) ABSTRACT

The present invention relates to a recordable optical record carrier which can be used to make a back-up of the full content of a SA-CD disc. The proposed record, carrier comprises: a first transparent substrate layer (1), a first semi-transparent recordable information layer (2) including an organic dye material having a high data storage capacity, a second transparent substrate layer (4), a second recordable information layer (5) including an organic dye material havingl, a lower data storage capacity than said first information layer (2), and a cover layer (6).

The present invention relates to a recordable optical record carrier comprising two different kinds of recordable information layers for recording information by means of a focused radiation beam.

A hybrid optical ROM-disc having two information layers that are compatible with different read-out systems is disclosed in U.S. Pat. No. 6,434,107. A hybrid Super-Audio CD (SA-CD) consisting of two information layers is described in the Super-Audio CD system description, part 1 physical description The first information layer of such a SA-CD is positioned at a depth of 1.2 mm and contains conventional CD-audio data This information layer can be read by existing CD-players using a wavelength λ of approximately 780 nm and a numerical aperture NA of 0.45. A second information layer is positioned at a depth of 0.6 mm. This second semi-transparent information layer is a high density (HD) layer and contains the audio data in super audio quality. This high density information layer is read using DVD-like optics using a wavelength λ of approximately 650 nm and a numerical aperture NA of 0.6.

Currently, no recordable media are available which can be used to make a back-up of the full content of such a SA-CD. It is therefore an object of the present invention to provide such a recordable optical record carrier.

This object is achieved according to the present invention by a recordable optical record carrier as claimed in claim 1 comprising:
a first transparent substrate layer,
a first semi-transparent recordable information layer including an organic dye material having a high data storage capacity,
a second transparent substrate layer,
a second recordable information layer including an organic dye material having a lower data storage capacity density than said first information layer, and
a cover layer.

The present invention is based on the idea to combine a conventional CD-R information layer having a low data density (data storage capacity) with a semi-transparent DVD+R information layer having a high data density. By this combination a recordable optical record carrier is obtained that, in principle, is capable of storing a back-up of the full content of a hybrid CD/DVD disc. Such a hybrid optical disc can be recorded in a combi-recorder (CD/DVD-recorder) with appropriate adaptions.

Preferred embodiments of the invention are defined in the dependent claims. Preferably the first information layer is an information layer as used as LO layer in a dual-layer DVD+R disc. Suitable layers to be used for dual-layer optical data storage media have been described in international patent applications PCT/IB03/00090 (PHNL 030043) and PCT/IB03/01377 (PHNL 030310). All descriptions regarding the L0 layer provided in these documents are herein incorporated by reference.

Preferred embodiments of the first information layer as described in these documents are defined in claims 3 to 6. According to a first preferred embodiment the first information layer has a first complex refractive index ñ_{λ2}=n_{λ2}−ik_{λ1} at a first wavelength λ₁ and a second complex refractive index ñ_{λ2}=n_{λ2}−ik_{λ2} at a second wavelength λ₂, a thickness d, an optical reflection value R₁ at said first wavelength λ₁ and an optical transmission value T₂ at said second wavelength λ₂, wherein the following conditions are fulfilled: T₂≧0.76, R₁≧0.15, n≧2.0, k₁<0.3, k₂<0.1 and d is in the range of λ₁/8n₁≦d<5λ₁/8n₁,λ₁ being the wavelength of a radiation beam used for recording information in the first information layer and λ₂ being the wavelength of a radiation beam used for recording information in said second information layer.

In order to achieve a reflectivity R₂ at said second wavelength λ₂ used for recording and read-out of the second information layer of at least 58% from the second information layer the first information layer is made highly transparent at the second wavelength λ₂ used for recording and read-out of the second information layer.

Preferably the transmission T₂ of the first information layer is selected to be at least 76% at a second wavelength of λ₂=780 nm, which is preferably used for recording on the second information layer. By a selection of the parameters as defined in claim 3 a sufficiently high transmission at the second wavelength, which is preferably 780 nm, and a sufficiently high reflectivity at the first wavelength, which is preferably 650 nm, are obtained, and, at the same time, the information layer can be easily produced. Further embodiments of this idea are described in the above mentioned international patent application PCT/IB03/01377, which further embodiments are herein incorporated by reference.

Preferred values of the thickness d_{RG} of the groove portion are defined in claim 5. Preferably, a non-metallic reflector layer is provided adjacent the first information layer, which additional reflective layer comprises a dielectric material e.g. SiO₂, SiC, ZnS, ZnS—SiO₂ (80:20), or a semiconducting material e.g. Si, and has a thickness d_{T} in the range 5 nm≦d_{T}≦120 nm.

In principle, it is possible to use a non-dye recordable information layer as first information layer. However, the use of dyes has the important advantage of a very high intrinsic transparency of the high density recording dye at the wavelength used for recording on the second (CD-R) information layer. In a further embodiment the first and second substrate layers have a thickness in the range of 0.55 to 0.65 mm, in particular in a range of 0.57 to 0.63 mm, preferably approximately 0.6 mm.

As already mentioned, an additional semi-transparent reflector layer is provided in a further embodiment between the first information layer and the second substrate layer. This additional reflector layer can be either a dielectric (non-metallic) mirror layer made of e.g. SiO₂ or SiC, or a metallic mirror layer, e.g. made of Ag. Moreover, the semi-transparent reflector layer can be made of more than one layer, for instance using dielectric mirror principles to further fine-tune the reflection at the wavelength used for recording/read-out at the first information layer (preferably k₁=650 nm) and the transmission used for recording/read out at the first information layer (preferably λ₂=780 nm).

Besides the above mentioned use for making a back-up of the full content of a SA-CD, the record carrier according to the present invention provides the possibility to distribute small volumes of SA-CDs since the efforts for producing read-only SA-CDs are quite high and expensive. Thus, instead of SA-CD-ROM discs recordable record carriers can be recorded with the same amount of information which is much easier and cheaper.

Furthermore, record carriers according to the present invention can be used for authoring in the production process of ROM discs. Before the start of a large-scale production of a disc, having e.g. audio-content, there is always made a first test-disc to check if the disc works properly, for instance to check if the content is correct and if the disc provides a good playback etc. This is rather expensive procedure as it requires a full production process comprising, among others, stamper fabrication, disc molding etc. It is much faster and cheaper to make a test recording of the content of the disc on a recordable record carrier. The record carrier according to the present invention can thus be used in the authoring process of an SA-CD disc.

The invention will now be explained in more detail with reference to the drawings in which

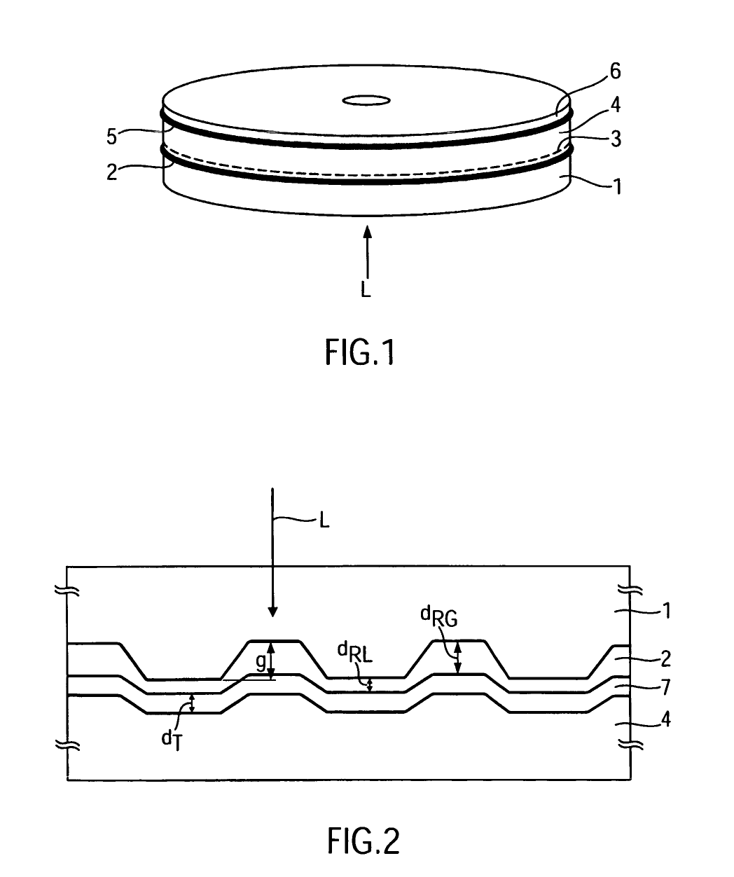

FIG. 1 shows a schematical layout of an optical record carrier according to the invention,

FIG. 2 shows a schematical layout of a portion of another embodiment of a record carrier according to the invention,

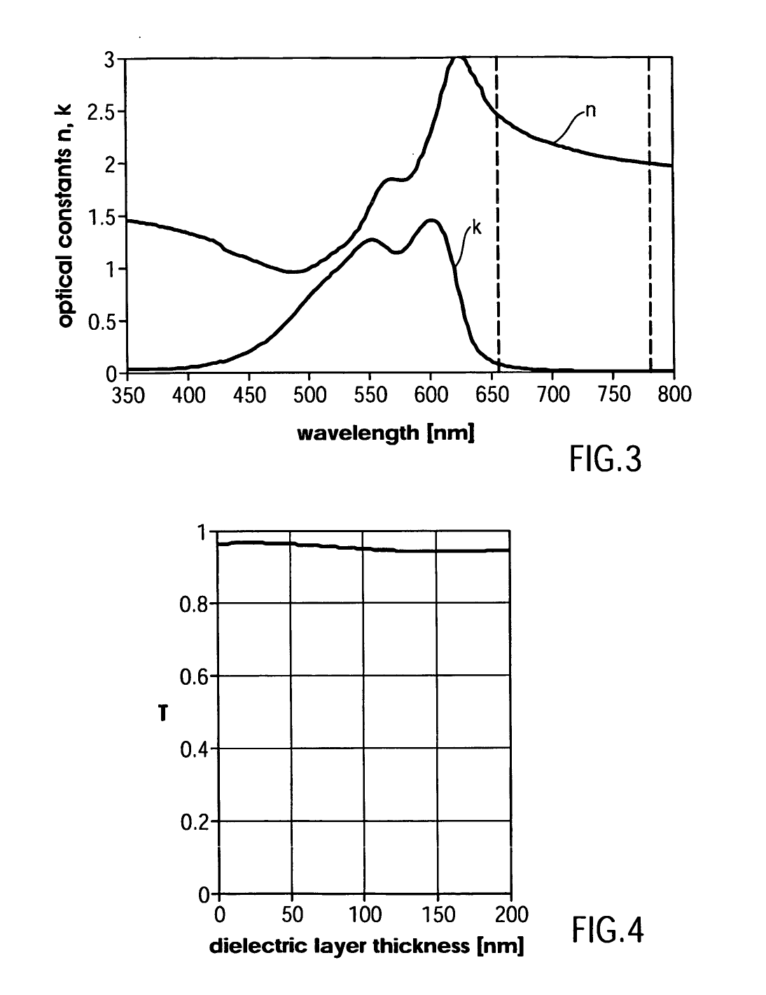

FIG. 3 shows the optical constants of a typical dye used for the first information layer,

FIG. 4 shows the transmission of a first information layer with a SiO₂ dielectric mirror layer at 780 nm,

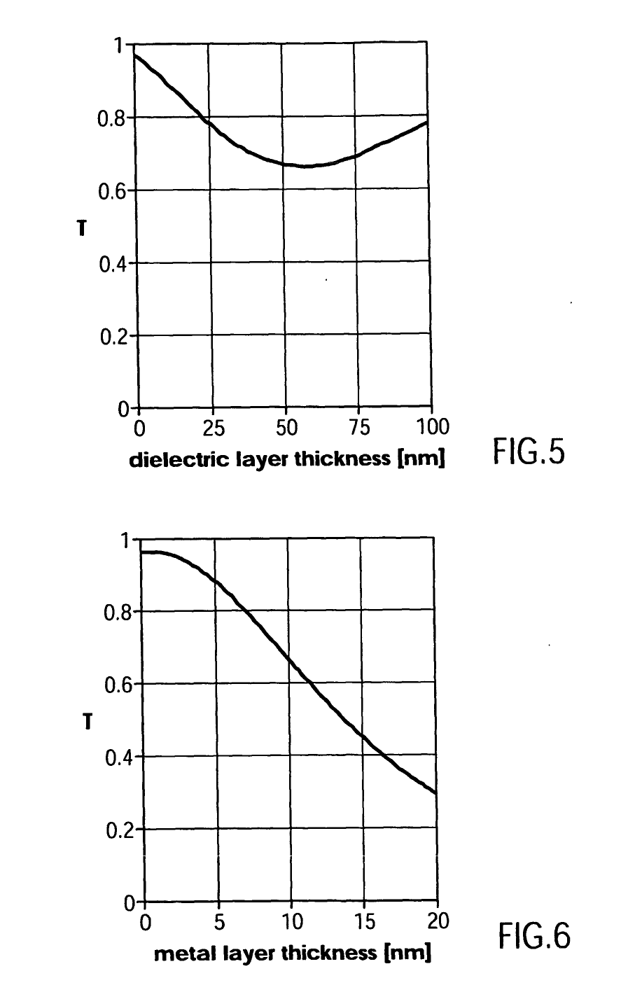

FIG. 5 shows the transmission of the first information layer with a SiC dielectric mirror layer at 780 nm and

FIG. 6 shows the transmission of the first information layer with a Ag metal mirror layer at 780 nm.

A schematic layout of a first embodiment of a record carrier according to the present invention is shown in FIG. 1. Seen from the side at which a recording/read out laser beam L having a wavelength λ is incident, the record carrier comprises the following layers:

a first transparent substrate layer, for instance having a thickness of approximately 0.6 mm;

a first at least semi-transparent recordable information layer 2 having a high data density and including an organic dye material as used for information layers in DVD+R, for instance having a thickness of approximately 80 nm;

an adhesive layer 3;

a second transparent substrate layer 4, for instance having a thickness of approximately 0.6 mm,

a second information layer 5 including an organic dye material as used in information layers of CD-R discs and having a lower data density than the first information layer 2, for instance having a thickness of 150 nm; and

a cover layer 6.

It should be noted that the information layer 2, 5 are shown as representative for appropriate recording stacks which generally also include further layers, such as dielectric, mirror or reflective layers which are not shown in FIG. 1 for simplicity's sake.

The position of the second information layer 5 is determined by the total optical thickness of the two substrate layers 1 and 4 and the adhesive layer 3, i.e. the position of the second information layer 5 is determined by the optical depth: n₁ d₁+n₄ d₄+n₃ d₃ wherein n indicates the real part of the complex refractive index ñ=n−i k at a second wavelength λ₂ (e.g. 780 nm) and d indicating the thickness. In a particular embodiment the position of the second information layer 5 is in an optical depth depth of 1.86±0.1, which results in an optical depth of the second information layer 5 that is identical to that in conventional CDs (CD substrate thickness 1.2 mm and CD substrate refractive index 1.55). The optical thickness n*d is relevant here; for the first information layer 2 this should be similar to CD: d*n=1.2 mm*1.55. The above calculations allows to correct the physical depth of the second information layer due to possibly different refractive inidices of the spacer, adhesive, and substrate layers.

For read-out and recording of data in the first information layer 2 a laser beam L is used having preferably a wavelength λ₁ of approximately 650 nm as is used in DVD+R technology while for read-out and recording of data in the second information layer 5 a laser beam L is used preferably having a second wavelength λ₂ of approximately 780 nm as is used in CD-R technology. A reflection level of the information layers 2 and 5 at the respective wavelength should be at least 15% and 58% respectively. To achieve this for the second information layer 5 it implies that the first information layer 2 must have a high transmission value T at the second wavelength λ₂ used for recording/read-out of data on the second information layer 5, i.e. at 780 nm. In a preferred embodiment the dye material is therefore selected such that the real part n₆₅₀ of the complex refractive index s₆₅₀ is at least 2.0 and that the imaginary part k₆₅₀ of the complex refractive index ñ₆₅₀ is smaller than 0.3 at a first wavelength λ₁ and that the imaginary part k₇₈₀ of the complex refractive index ñ₇₈₀ is smaller than 0.1 at the second wavelength λ₂.

Furthermore, it has been shown to be advantageous that for the thickness of the first information recording layer 2 it holds: λ₁/8n≦d≦3λ₁/8n in case of a non-metallic semitransparent reflector layer adjacent the first recording layer or λᵢ/8n≦d≦5λ₁/8n in case of a thin metallic semitransparent reflector layer adjacent the first information layer wherein λ₁ is the wavelength used for recording/read-out of data of the first information layer 2, thus for instance being 650 nm.

A portion of an embodiment of a record carrier according to the invention is schematically shown in FIG. 2. In this embodiment an at least semi-transparent reflector layer 7 is provided between the first information layer 2 and the second substrate layer 4, said first information layer 2 and said reflector layer 7 forming a recording stack, which could possibly include additional layers (not shown) for the purpose of e.g. reflection/transmission tuning, chemical stability, etc. It should be noted that the adhesive layer 3 is provided, but not shown, but can be also left out completely in a particular embodiment. Moreover, the groove 10 structure of the substrate layer I as well as the first information layer 2 and the additional reflector layer 7 is shown. As can be seen, the first substrate layer 1 has a guide groove having a depth g and the first information layer 2 has different thicknesses, a first thickness d_{RG} in the groove portion which is larger than a thickness d_{RL} in the portion between the grooves. In contrast, the additional reflector layer 7 substantially has a constant thickness d_{T}. In order to obtain good signals at the wavelength λ₁ used for read-out/recording of the first information layer 2 a good selection for the groove depth is such that (λ₁/650)*50 nm<g<(λ₁/650)*180 nm, depending on the detailed stack design.

Moreover, preferred values for the thicknesses are such that it holds for d_{RG}: wherein the thickness d_{RG} of said first information layer fulfils the condition 145 nm<d_{RG}·n<245 nm. The thickness d_{RL} in the portion between the grooves should be in the range d_{RG}−0.2*g≦d_{RL}≦d_{RG}−0.5*g, while the thickness d_{T} of the reflector layer 7 should be in the range 5≦d_{T}≦120 nm. Particular values for the groove depth g are 50 nm<g<180 nm. Practical exemplary values of a particular embodiment are: g=80 nm, d_{T}=60 nm, d_{RL}=32 nm, d_{RG}=80 nm.

FIG. 3 shows the optical constants n, k of a typical dye material used for the first information recording stack comprising the first information layer 2 and the reflector layer 7. As can be seen, at the wavelength λ=780 nm used for recording/read-out of the second information layer, n is approximately 2.0 and k is approximately 0, while at the wavelength λ=655 nm used for recording/read-out of the first information layer 2, n is about 2.4 and k is about 0.1.

Different materials can be used for the reflector layer 7. The transmission at a wavelength of 780 nm of the first information layer 2 with the additional reflector layer 7 for different materials, in particular for an additional SiO₂ dielectric reflector layer, and additional SiC dielectric reflector layer and an additional Ag metal reflector layer are shown in the FIGS. 4, 5 and 6, respectively, depending on the reflector thickness. By use of these diagrams an appropriate thickness can be selected such that the transmission is in the desired range.

The present invention provides a recordable optical record carrier which can be used for making a back-up of the full content of a read-only hybrid SA-CD. Furthermore, small volumes of hybrid SA-CDs can be distributed by use of record carriers according to the present invention. Still further, such record carriers can be used in the authoring process of hybrid read-only SA-CD discs.

1. Recordable optical record carrier comprising:
a first transparent substrate layer (1),
a first semi-transparent recordable information layer (2) including an organic dye material having a high data storage capacity,
a second transparent substrate layer (4),
a second recordable information layer (5) including an organic dye material having a lower data storage capacity than said first information layer (2), and
a cover layer (6).

2. Record carrier as claimed in claim 1, wherein said first information layer (2) is an information layer as used as LO layer in a dual-layer DVD+R disc.

3. Record carrier as claimed in claim 1, wherein said first information layer (2) has a first complex refractive index n~λ1=n λ1−i k λ1 at a first wavelength λ1 and a second complex refractive index n~λ2=n λ2−i k λ2 at a second wavelength λ2, a thickness d, an optical reflection value R1 at said first wavelength λ1 and an optical transmission value T2 at said second wavelength λ2, wherein the following conditions are fulfilled: T2≧0.76, R1≧0.15, n1≧2.0, k1<0.3, k2<0.1 and d is in the range of λ1/8n1≦d≦5λ1/8n1, λ1 being the wavelength of a radiation beam used for recording information in the first information layer (2) and λ2 being the wavelength of a radiation beam used for recording information in said second information layer (5).

4. Record carrier as claimed in claim 1, wherein said first substrate layer (1) comprises a guide groove having a depth g, the guide groove being present at the side of the substrate layer adjacent said first information layer and wherein said first information layer (2) has a complex refractive index n~=n−i k at a wavelength λ of a radiation beam used for recording information, a thickness dRG in the groove portion and a thickness dRL in the portion between the grooves, said groove depth g being in the range (X/650)*50 nm<g<(X/650)*180 nm with λ expressed in nm.

5. Record carrier as claimed in claim 4, wherein the thickness dRG of said first information layer (2) fulfils the condition 145 nm≦dRG*n≦245 nm.

6. Record carrier as claimed in claim 3, wherein the first wavelength λ1 is approximately 650 nm and the second wavelength λ2 is approximately 780 nm.

7. Record carrier as claimed in claim 1, wherein said second information layer (5) is an information layer as used in a CD-R disc.

8. Record carrier as claimed in claim 1, wherein said first and said second substrate layers (2, 5) have a thickness in the range of 0.55 to 0.65 mm, in particular of substantially 0.6 mm.

9. Record carrier as claimed in claim 1, further comprising an additional semi-transparent reflector layer (7) between said first information layer (2) and said second substrate layer (4), in particular a dielectric mirror layer made of SiO2 or SiC or a metallic mirror layer made of Ag.
